(19) United States
(12) Patent Application Publication
(10) Pub. No.: US 2008/0128180 A1
(43) Pub. Date: Jun. 5, 2008

(54) Position Detecting System and Apparatuses and Methods For Use and Control Thereof

(76) Inventors: Haim Perski, Hod-HaSharon (IL); Avi Ezer Ben-Eliyahu, Tzur-Hadassa (IL)

Correspondence Address: Martin D. Moynihan;PRTSI, P.O.Box 16446, Arlington, VA, 22215, US

(21) Appl. No.: 11/791,861

(22) PCT Filed: Dec. 1, 2005
(86) PCT No.: PCT/IL05/01297

§ 371 Date: May 30, 2007

Related U.S. Application Data
(60) Provisional application No. 60/631,862, filed on Dec. 1, 2004.
(60) Provisional application No. 60/657,439, filed on Mar. 2, 2005.

(51) Int. Cl. G06F 3/041

(52) U.S. Cl. 178/18.03

(57) ABSTRACT

A position detection system, comprising: at least one pointer, comprising: a wave generating oscillator section; a power supply section powering the oscillator section, and an energy pick-up circuit which supplies energy to the power supply section from an excitation signal received by the circuit; and, a detector, comprising a sensor operative to detect the position of the at least one pointer from a wave generated by the wave generating section.

### RELATED APPLICATIONS

This application claims the benefit under 119(e) of U.S. provisional patent application 60/631,862, filed Dec. 1, 2004, and U.S. provisional patent application 60/657,439, filed Mar. 2, 2005, both applications entitled “Electromagnetic Stylus for a Digitizer System”. The disclosures of both applications are incorporated herein by reference.

### FIELD OF THE INVENTION

The present application is concerned with apparatuses and methods for the use and control of a position detecting system.

### BACKGROUND OF THE INVENTION

Electromagnetic styluses are known in the art for use and control of a digitizer system. For example, U.S. Pat. No. 4,878,553, the disclosure of which is incorporated herein by reference, describes an electromagnetic stylus, used in conjunction with a tablet type sensor. The sensor comprises a set of loop coils transmitting an EM wave to a resonant circuit within the stylus, mainly by magnetic coupling. A high conductivity loop is used to allow for a high enough current to provide a relatively high magnetic field when activated by a source.

The resonant circuit in the stylus resonates at the same frequency as the transmitted EM wave. The EM field of the stylus produces its own magnetic field at the same frequency as the signal that is received induces a signal on the loop coils in the sensor. This signal is detected by a receiving element that has meanwhile replaced the source. The clear disadvantage of this implementation is that the EM wave transmitted by the conductive loop coils should be identical to the resonance frequency of the EM stylus. Most digitizer systems provide information not only regarding the stylus position, but also concerning its status, the pressure level applied to the tip etc. To cope with these demands, a manual switch is utilized to connect an additional capacitance to the resonant circuit within the stylus. In addition, a variable capacitance is also connected in parallel to the resonant circuit. The capacitance of the variable capacitance changes according to the amount of pressure applied to the stylus tip. The receiver determines the change in resonant frequency by measuring a change in the phase of the signal retransmitted by the stylus.

U.S. Pat. No. 5,565,632, the disclosure of which is incorporated herein by reference, describes a stylus comprising variable inductance in order to provide pressure detection. The applied pressure to the stylus' tip changes the inductance of the resonant circuit causing a continuous shift in the resonance frequency.

A disadvantage of a resonance type stylus is the inability to transmit and receive at the same time, especially when using a peripheral excitation coil.

U.S. Pat. No. 5,571,997, the disclosure of which is incorporated herein by reference, describes an alternative design of an EM stylus comprising a battery operated stylus. In this case, the energy is supplied to the stylus by the battery. However, the use of a battery operated stylus has several drawbacks. The battery's life span is limited. Once the battery is weak the user will be unable to use the digitizer system. A battery operated stylus requires constant maintenance which is a liability to the user. In addition the stylus is relatively heavier and its design is limited by the dimensions of the battery. An additional disadvantage of a battery operated stylus is that the stylus is not synchronized with the system. When the stylus is synchronized to the digitizer, it is possible to use the phase information for a variety of purposes such as noise elimination, etc.

U.S. Pat. No. 6,690,156, the disclosure of which is incorporated herein by reference, describes a positioning device capable of detecting multiple physical objects, preferably styluses, located on top of a flat screen display. One of the preferred embodiments describes a sensor built of transparent foils containing a matrix of vertical and horizontal conductors. The stylus includes an oscillating circuit, which is energized by a peripheral coil surrounding the sensor. The exact position of the stylus is determined by processing the signals that are sensed by the sensor.

Other references describe styluses that are electrically connected to the digitizer system by a cable or a cord. In this case the energy is supplied to the stylus via the electrical connection to the digitizer. However, these designs make it hard for the user to manipulate the stylus.

### SUMMARY OF THE INVENTION

An aspect of some exemplary embodiments of the invention relates to providing a pointer, such as a stylus, which utilizes at least one energy pick-up circuit designed to derive energy from an excitation signal transmitted to the stylus. Optionally, a pointer is a game piece or other object whose position can be detected by a position detection system. Optionally, a plurality of pointers is used in connection with the position detection system. Optionally, the stylus uses the derived energy to provide power to a signal generator and/or a transmitting circuit that transmits a signal to the sensor at a frequency independent of the excitation signal. Optionally, the stylus is comprised of a power supply section, an oscillator section and a transmission section. Optionally, the transmission section is comprised of a transformer. Optionally, the stylus has more than one power supply section. Optionally, the stylus has a transistor in place of a transformer in the transmission section

In an embodiment of the invention, the power supply section is comprised of an energy pick-up circuit and circuitry to condition the energy for use in the transmitter.

In some exemplary embodiments of the invention, the electromagnetic stylus is for use and control of the digitizer system. Optionally, the stylus is utilized to send information such as position coordinates, status, pressure level, mouse emulation (such as “right-click”) and other related use and control information to the digitizer system. Optionally, the electromagnetic stylus is for use and control of at least one of: a tablet personal computer (tablet “PC”), a stylus-enabled lap-top PC, a personal data assistant (“PDA”) or any hand held device such as a mobile phone. In some exemplary embodiments of the invention, the stylus is cordless.

In an embodiment of the invention, the electromagnetic stylus uses a rechargeable power supply, which is recharged by the energy pick-up circuit. Optionally, the stylus uses a rechargeable battery as a stable power source. Recharging utilizing the pick-up circuit allows for the use of a smaller battery which does not have to be replaced.

An aspect of some exemplary embodiments of the invention relates to providing a pressure sensitive stylus utilizing one of the power methods described above. In an exemplary embodiment of the invention, an oscillation frequency of the stylus is modified depending on user applied pressure to the stylus. Optionally, a user applies pressure to the stylus using at least one button located on an exterior of the stylus. Optionally, a user applies pressure to the stylus by pressing the tip into a digitizer surface. In some exemplary embodiments of the invention, pressure changes trigger changes in the frequency emitted by the stylus. Optionally, certain frequencies correspond to certain commands executable by the digitizer. Optionally, a range of frequencies corresponds to a certain command. In some exemplary embodiments of the invention, a command includes to change colors being used on digitizer. Optionally, a command includes switching stylus to an eraser function for deleting data entered on the digitizer.

There is thus provided in accordance with an exemplary embodiment of the invention, a position detection system, comprising: at least one pointer, comprising: a wave generating oscillator section; a power supply section powering the oscillator section, and an energy pick-up circuit which supplies energy to the power supply section from an excitation signal received by the circuit; and, a detector, comprising a sensor operative to detect the position of the at least one pointer from a wave generated by the wave generating section. Optionally, the excitation signal is transmitted from the detector. Optionally, the power supply produces a DC voltage to power the oscillator section. Optionally, the energy pick-up circuit comprises a coil which is excited by the excitation signal. Optionally, the power supply section further comprises a rechargeable battery. Optionally, the rechargeable battery recharges from energy derived by the energy pick-up circuit. Optionally, the power supply section further comprises a capacitor. Optionally, the capacitor is charged from the energy pick-up circuit. In some exemplary embodiments of the invention, the pointer further comprises a transmission section that is powered by a transmission power supply section. Optionally, the transmission power supply section is comprised of a transmission power supply section energy pick-up circuit which is excited by the excitation signal circuit and which supplies energy to the power supply section from the excitation signal. Optionally, the transmission power supply section energy pick-up circuit comprises a coil which is excited by the excitation signal. Optionally, the transmission power supply section energy pick-up circuit further comprises a rechargeable battery. Optionally, the oscillator section further comprises at least a variable element responsive to pressure exerted on the pointer by a user. Optionally, the pressure is exerted, a first frequency generated by the oscillator section changes to a second frequency. Optionally, the first frequency corresponds to at least a first executable command and wherein the second frequency corresponds to a second executable command on the detector. Optionally, the variable element is a capacitor. Optionally, the variable element is a resistor. Optionally, the variable element is an inductor. Optionally, the excitation signal is generated by the detector. Optionally, the detector is a display. Optionally, the oscillator section generates a wave at a frequency independent of the excitation signal. Optionally, the pointer further comprises at least one synchronization circuit which synchronizes the oscillator section wave generation with the excitation signal. Optionally, the detector is at least one of: a personal computer, a personal data assistant, a tablet or a mobile phone.

There is thus provided in accordance with an exemplary embodiment of the invention, a pointer, comprising: a wave generating oscillator section; a power supply section powering the oscillator section, and an energy pick-up circuit which supplies energy to the power supply section from an excitation signal received by the circuit; and, a transmission section that transmits a signal generated by the oscillator section. Optionally, the power supply produces a DC voltage to power the oscillator section. Optionally, the power supply section further comprises at least one synchronization circuit which synchronizes the oscillator section signal generation with the excitation signal. Optionally, the energy pick-up circuit comprises a coil which is excited by the excitation signal. Optionally, the power supply section further comprises a rechargeable battery. Optionally, the rechargeable battery recharges from energy derived by the energy pick-up circuit. Optionally, the power supply section further comprises a capacitor. Optionally, the capacitor is charged from the energy pick-up circuit. Optionally, the power supply section further comprises at least one “power-good” circuit. Optionally, the pointer further comprises at least a transmission power supply section powering the transmission section. Optionally, the transmission power supply section is comprised of a transmission power supply section energy pick-up circuit which is excited by the excitation signal circuit and which supplies energy to the power supply section from the excitation signal. Optionally, the transmission power supply section energy pick-up circuit comprises a coil which is excited by the excitation signal. Optionally, the transmission power supply section energy pick-up circuit further comprises a rechargeable battery. Optionally, the oscillator section generates a signal at a frequency independent of the excitation signal. Optionally, the oscillator section further comprises at least a variable element responsive to pressure exerted on the pointer by a user. Optionally, the pointer further comprises a button located on an exterior of the pointer wherein the button controls the at least a variable element responsive to pressure exerted on it from the button. Optionally, the pressure is exerted on the apparatus from a tip of the apparatus. Optionally, when the pressure is exerted, a first frequency generated by the oscillator section changes to a second frequency. Optionally, the second frequency is one of a relatively narrow range of frequencies. Optionally, the second frequency corresponds to a change of color function of the apparatus. Optionally, the variable element is a capacitor. Optionally, the variable element is a pressure sensitive resistor. Optionally, the variable element is an inductor.

There is thus provided in accordance with an exemplary embodiment of the invention, a method for providing energy to a pointer, comprising: transmitting an excitation signal from a detector; generating a DC voltage from the excitation signal; and, powering an oscillator from the DC voltage.

There is thus provided in accordance with an exemplary embodiment of the invention, a pointer, comprising: a pointer tip; at least one conductive element located in the pointer tip; a variable element, wherein the variable element modulates in response to motion of the at least one conductive element towards the variable element; at least one o-ring positioned around the at least one conductive element such that during the motion of the conductive element, torsion is applied to the o-ring and wherein the o-ring torsion opposes motion of the conductive element towards the variable element. Optionally, the o-ring torsion provides a force to return the conductive element to a condition that existed prior to the motion towards the variable element. Optionally, the at least one conductive element is a ferrite. Optionally, the variable element is a resistor. Optionally, the variable element is a capacitor. In some exemplary embodiments of the invention, the pointer further comprises an oscillator section in operative communication with the variable element. Optionally, the pressure exerted on the pointer tip causes motion of the at least one conductive element towards the variable element.

### BRIEF DESCRIPTION OF THE DRAWINGS

Exemplary non-limiting embodiments of the invention are described in the following description, read with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. In the attached figures:

FIG. 1 is an illustration showing an electromagnetic stylus in proximity to a digitizer in accordance with an exemplary embodiment of the invention;

FIG. 2A is a schematic showing an electrical configuration of an electromagnetic stylus in accordance with an exemplary embodiment of the invention;

FIG. 2B is a circuit diagram showing a configuration of a synchronization circuit in accordance with an exemplary embodiment of the invention;

FIG. 3 is a schematic showing an electrical configuration of an electromagnetic stylus in accordance with an exemplary embodiment of the invention;

FIG. 4A is a schematic showing an electrical configuration of a high voltage electromagnetic stylus in accordance with an exemplary embodiment of the invention;

FIG. 4B is an exemplary excitation waveform transmitted to a stylus in accordance with an exemplary embodiment of the invention;

FIG. 5 is a schematic showing a stylus configuration using a rechargeable battery as a power supply in accordance with an exemplary embodiment of the invention;

FIG. 6A is a schematic showing an electrical configuration of a dual power supply electromagnetic stylus in accordance with an exemplary embodiment of the invention;

FIG. 6B is a circuit diagram showing a configuration equivalent to a transistor of FIG. 6A in accordance with an exemplary embodiment of the invention;

FIG. 7 is a diagram of wave forms of the oscillator output and the stylus tip in accordance with an exemplary embodiment of the invention;

FIG. 8A is a schematic showing an electrical configuration of a pressure sensitive stylus in accordance with an exemplary embodiment of the invention;

FIG. 8B shows a diagram of relative frequency ranges achieved using a pressure sensitive stylus in accordance with an exemplary embodiment of the invention;

FIG. 9A is a schematic showing an electrical configuration of a pressure sensitive stylus in accordance with an exemplary embodiment of the invention;

FIG. 9B shows a diagram of a frequency range relative to a frequency achieved using a pressure sensitive stylus in accordance with an exemplary embodiment of the invention;

FIG. 10 is a schematic diagram of a pressure sensitive stylus in accordance with an exemplary embodiment of the invention;

FIG. 11A is a schematic showing an electrical configuration of a dual power supply pressure sensitive stylus in accordance with an exemplary embodiment of the invention;

FIG. 11B is an exemplary circuit diagram of an oscillator in accordance with an exemplary embodiment of the invention; and,

FIG. 11C is a schematic showing an electrical configuration of a resistor, which is a series of resistors in accordance with an exemplary embodiment of the invention.

### DETAILED DESCRIPTION OF EXEMPLARY EMBODIMENTS

The present invention is best understood when described in conjunction with position detecting systems, such as a digitizer. U.S. Pat. No. 6,690,156 and U.S. patent application Ser. No. 10/649,708, entitled “Transparent Digitizer”, the disclosures of which are herein incorporated by reference, describe positioning detecting devices capable of detecting multiple physical objects, such as styluses, located on top of a flat screen display. One of the preferred embodiments in both disclosures describes a sensor built of transparent foils containing a matrix of vertical and horizontal conductors. Optionally, the electromagnetic stylus is for use and control of at least one of: a tablet personal computer (tablet “PC”), a stylus-enabled lap-top PC, a personal data assistant (“PDA”) or any hand held device such as a mobile phone. The stylus includes an oscillating circuit, which is energized by a peripheral coil surrounding the sensor. The exact position of the stylus is determined by processing the signals that are sensed by the sensor. Optionally, the stylus combines an ink writing ability with electromagnetic functionality.

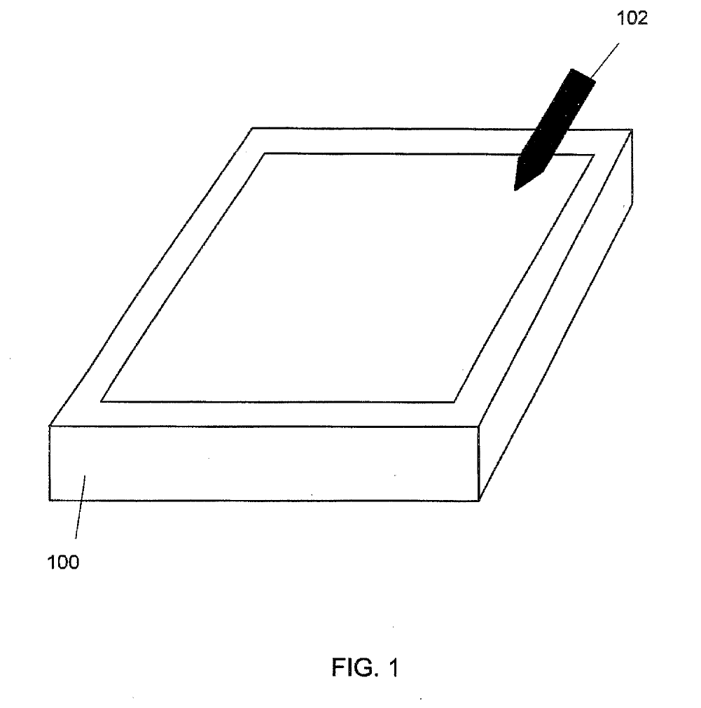

While the above disclosures describe placing the digitizer on top of the display screen, using a transparent digitizer or using a passive electromagnetic stylus, it should be understood that the present invention is an electromagnetic stylus optionally capable of use with the devices described therein, such as shown in FIG. 1. It should be understood that a digitizer 100 detects the position of at least one pointer in a very high resolution and with a high update rate. The pointer can be either a stylus 102, a user's finger (i.e. touch), a game piece and/or any conductive object touching the screen. Optionally, the pointer is only located over the screen but doesn't touch it. The pointer may be used for pointing, painting, writing (handwriting recognition) and any other activity that is typical for user interaction with the device. The system can detect single or multiple finger touches. The system can detect several electromagnetic objects, either separately or simultaneously. In some cases finger touch detection is used in conjunction with stylus detection. As described herein, a pointer capable of use with a digitizer system is a stylus, such as those described below.

### Exemplary Embodiments with One Power Supply Section

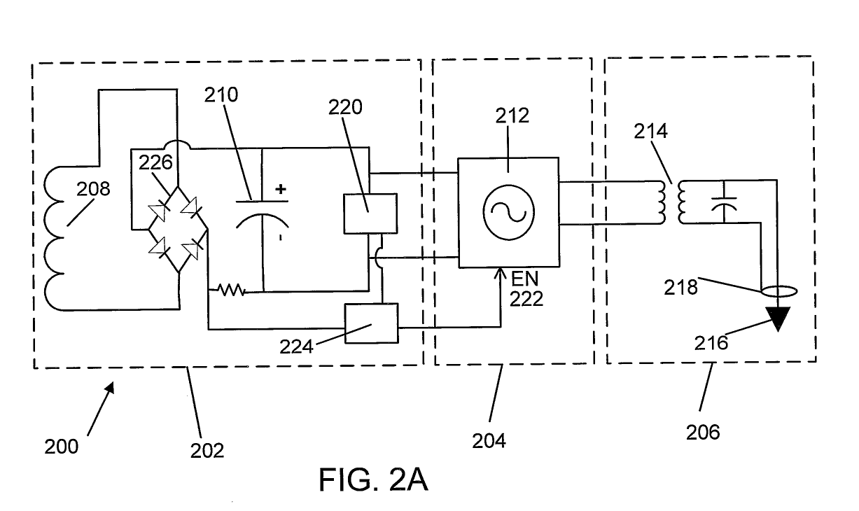

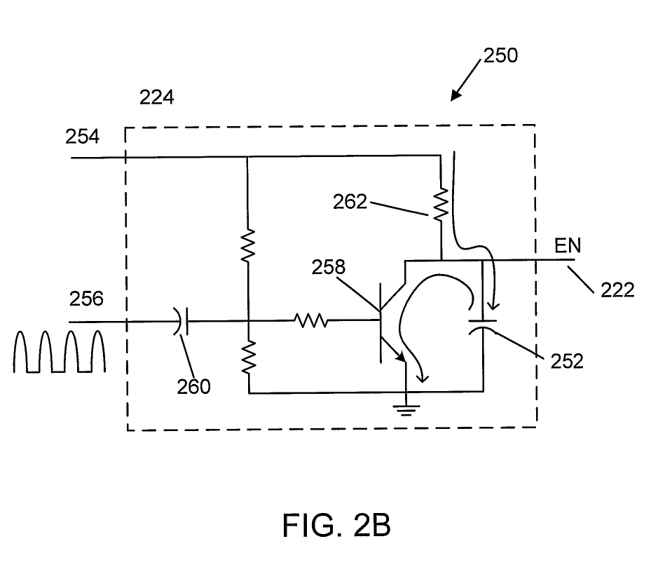

FIG. 2A shows a schematic 200 of an electrical configuration of an electromagnetic stylus 102, in accordance with an exemplary embodiment of the invention. In an exemplary embodiment of the invention, an EM stylus 102 (FIG. 1) comprises at least three main sections: a power supply section 202, an oscillator section 204, and a transmission section 206. These three designations for the main sections of the stylus are adhered through in the following specification, despite changes in the inner workings of the sections. In general, an embodiment of the section shown in one of the Figs. is interchangeable or almost interchangeable with the same section in a second embodiment of the stylus.

In an exemplary embodiment of the invention, power supply section 202 is designed as an energy pick up circuit, described in more detail below, which receives energy from an electromagnetic wave transmitted by digitizer 100. The transmitted EM wave induces current on an inductor 208, which charges a capacitor 210 through a diode bridge 226 in accordance with some exemplary embodiments of the invention. Inductor 208 has a parasitic capacitance which dictates its ability to utilize the transmitted EM energy. The parasitic capacitance is a known characteristic that determines the inductor's resonance frequency, optionally the frequency being where energy reception is the most efficient.

In an exemplary embodiment of the invention, capacitor 210 stores the energy transmitted by the digitizer and serves as a power supply to the oscillator 212 located in oscillator section 204. In an exemplary embodiment of the invention, the oscillation frequency of oscillator 212 is completely independent of the EM wave sent by the digitizer through the energy pick-up circuit to charge capacitor 210. The oscillator 212 output is optionally coupled to a transmission section 206. In this embodiment a transformer 214 is located in transmission section 206 amplifies the voltage of the oscillating signals and, in some exemplary embodiments of the invention, couples it to a stylus tip 216 and an opening 218 surrounding stylus tip 216. In an exemplary embodiment of the invention, stylus 102 transmits an electric field to a sensor located on digitizer 100. However, other stylus embodiments may transmit a magnetic field additionally or alternatively to the electric field.

In an exemplary embodiment of the invention, the energy pick-up circuit receives signals from a peripheral coil located on digitizer 100. Optionally, the energy pick-up circuit receives signals from at least one loop coil located on digitizer 100. The peripheral coil transmits an AC signal of a certain frequency which produces an EM field. When stylus 102 is placed within range of said EM field, a current is induced on inductor 208 within the energy pick-up circuit. Since the induced current is an AC current, a diode bridge 226 or an equivalent rectifying circuitry is utilized to charge capacitor 210 in accordance with some exemplary embodiments of the invention. The charged capacitor 210 is optionally connected to a voltage regulating circuit 220 which assures that oscillator 212 is provided with a fixed and stable voltage supply. In an exemplary embodiment of the invention, the voltage level produced by capacitor 210 reflects the amount of current induced on inductor 208. The current induced on inductor 208 depends on various factors such as the stylus position with respect to the sensor, the stylus tilt etc. In an exemplary embodiment of the invention, voltage regulating circuit 220 makes sure oscillator 212 is provided with the correct and stable voltage level required for its operation.

In an exemplary embodiment of the invention, the stylus signal is synchronized with the digitizer system. The operation cycle of the digitizer system is optionally as follows:
Excitation Phase
   The peripheral coil transmits an EM field in the proximity of the sensor
   The stylus 102 stores the transmitted energy in the designated capacitor 210. During this time, oscillator 212 is disabled.
Detection Phase
   The digitizer 100 stops transmitting through the peripheral coil.
   The oscillator 212 is enabled—transmitting an AC signal to the digitizer sensor.

During the Excitation Phase conductive antennas comprising the sensor are under the influence of the same EM field that energizes stylus 102. Under these conditions it is difficult to pick up the stylus signals, even if the excitation frequency is different from the stylus frequency, since the detection system might be saturated. Therefore, in an exemplary embodiment of the invention, digitizer 100 samples the sensor's antennas during the detection phase.

Another advantage of using separate Excitation and Detection Phases is that when oscillator 212 is disabled its power consumption is minimized, which allows efficient and sufficient charging of capacitor 210. Other embodiments optionally use simultaneous stylus reception and transmission. In an exemplary embodiment of the invention, saturation of the detection unit is avoided using simultaneous reception and transmission by transmitting the excitation signal in a frequency much higher or much lower than the stylus frequency.

In an exemplary embodiment of the invention, an enable signal 222 provided to oscillator 212 is generated in a synchronization circuit 224, which is a part of power supply section 202. Synchronization circuit 224 activates oscillator 212 using enable signal 222 as soon as digitizer 100 stops transmitting the excitation signal, in an exemplary embodiment of the invention. Optionally, a portion of the received signal is transferred to synchronization circuit 224. In an exemplary embodiment of the invention, synchronization circuit 224 senses the oscillating signal on inductor 208 and enables oscillator 212 once the oscillations on inductor 208 have stopped. In some exemplary embodiments of the invention, a stable voltage is provided to synchronization circuit 224 by voltage regulating circuit 220.

FIG. 2B shows a circuit diagram 250 of a synchronization circuit in accordance with an exemplary embodiment of the invention. The synchronization is optionally performed by measuring the load current at the output of diode bridge 226. As soon as the Excitation Phase is over, the current from diode bridge 226 to capacitor 210 ceases.

In accordance with an exemplary embodiment of the invention, a second capacitor 252 within synchronization circuit 224 is charged and when it reaches a certain level it activates oscillator 212. Synchronization circuit 224 receives two input signals, a first input signal 254 is a stable voltage level provided by voltage regulating circuit 220 and a second input signal 256 is the output of the diode bridge 226. The output of synchronization circuit 224 serves as an enable signal 222 for oscillator section 204. In the preferred embodiment the output of the synchronization circuit 224 is connected to the oscillator through a Schmidt trigger (not shown). First input signal 254 is utilized to charge capacitor 252. However, the incoming signals from second input signal 256 open transistor 258 and allow capacitor 252 to discharge. Capacitor 260 is used to filter out the DC signal allowing only the AC signals to reach the transistor's 258 gate. Resistor 262 sets the charge rate of capacitor 252. Resistor 262 is selected to ensure that the capacitor 252 will not be fully charged as long as the input pulses on second input signal 256 still exist. Once the Excitation Phase has ended, capacitor 252 is charged through transistor 258 and the enable signal 222 is set.

In some exemplary embodiments of the invention, oscillator 212 is synchronized to start after the beginning of the excitation signal, a different point in time, such as start of the Excitation Phase. Optionally, the pattern of the excitation signal is controlled. For example, the excitation signal is divided into two sections with a signal gap in between, and the oscillation is synchronized to any time point within that signal gap.

In some exemplary embodiments of the invention, different types of sensing and/or excitation means are used that do not necessarily require synchronization between the transmitted stylus signal and the digitizer system. In these cases, synchronization circuit 224 is optionally omitted.

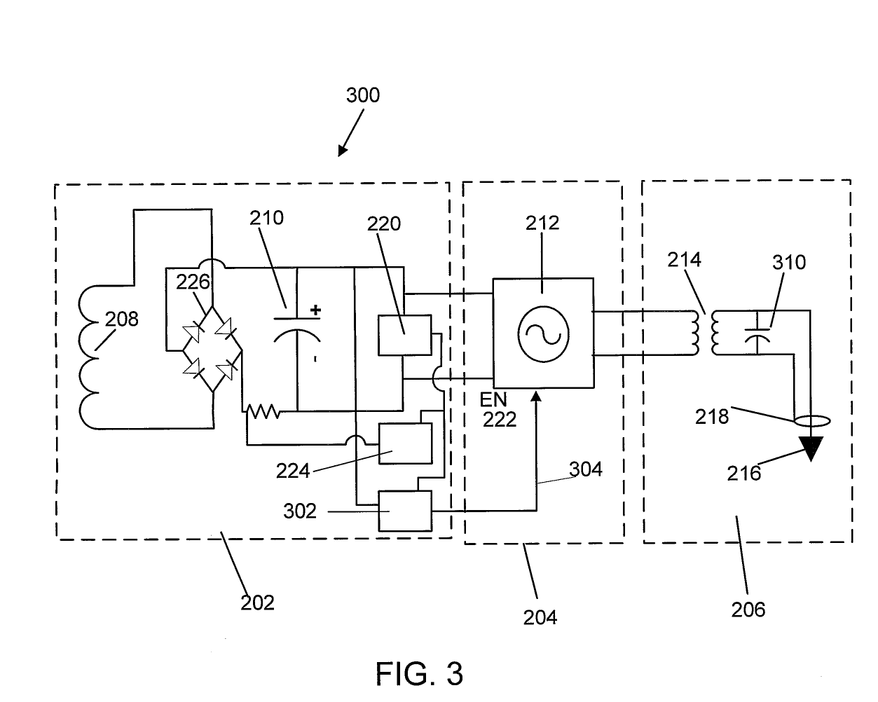

Referring to FIG. 3, a schematic 300 is shown depicting an electrical configuration of an electromagnetic stylus 102, in accordance with an exemplary embodiment of the invention. In an exemplary embodiment of the invention, a peripheral coil on digitizer 100 transmits an AC signal of a certain frequency, which produces an EM field in the proximity of a sensor located on digitizer. When stylus 102 is placed within range of said EM field, a current is induced on inductor 208 within the energy pick-up circuit. Optionally, inductor 208 is a coil. Since the induced current is an AC current, a diode bridge 226 or an equivalent rectifying circuitry is used to charge capacitor 210. The energy pick-up circuit is also comprised of a synchronization circuit 224 as described above, and in some exemplary embodiments of the invention, a “power good” circuit 302. The “power good” circuit 302 makes sure oscillator 212 is provided with the correct voltage level required for its operation, in accordance with some exemplary embodiments of the invention. In an exemplary embodiment of the invention, the voltage provided to oscillator section 204 is DC voltage.

A disable signal 304 provided to oscillator 212 is generated in “power good” circuit 302. In an exemplary embodiment of the invention, “power good” circuit 302 disables oscillator 212 in cases where the voltage is below a certain predetermined threshold. Optionally, the threshold is set at a minimum voltage necessary for oscillator 212 to function in accordance with an embodiment of the invention. “Power good” circuit 302 measures the voltage formed on capacitor 210. Optionally, “power good” circuit 302 receives two input signals, a first input signal is a stable voltage level provided by the voltage regulating circuit 220 and a second input signal is the output of diode bridge 226. The output of the “power good” circuit 302 is the disable signal 304 for oscillator section 204.

In an exemplary embodiment of the invention, transmission section 206 is operationally connected to oscillator 212. In an exemplary embodiment of the invention, a capacitor 310 is added to the secondary coil within the transformer 214 in order to introduce higher impedance at the oscillator output. Due to capacitance 310 the oscillator's output signal intensified. The combined impact of the capacitance 310 and transformer 214 generates an electric field at stylus tip 216, 218 sufficient for the purposes of this invention. Other embodiments may find it sufficient to use the transformer 214 without the aid of capacitor 310.

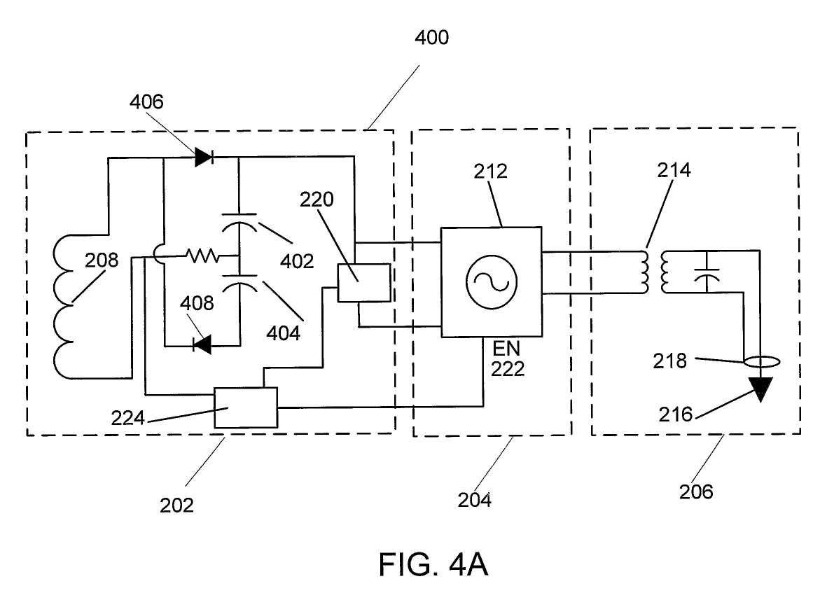

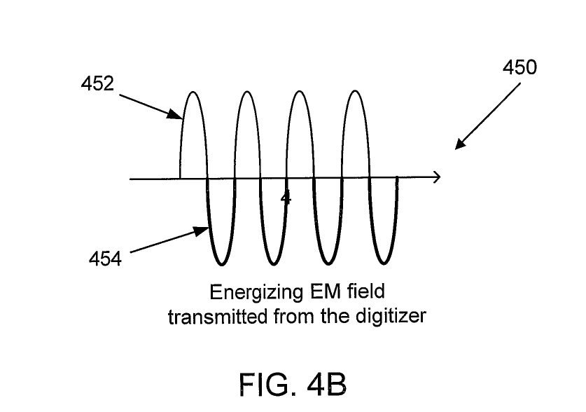

In FIG. 4A a schematic 400 of a high voltage electromagnetic stylus is depicted, in accordance with an exemplary embodiment of the invention. In the embodiment shown in FIG. 4A, the voltage level provided to oscillator 212 is significantly higher than the embodiment depicted in FIG. 2A. In an exemplary embodiment of the invention, first capacitor 402 and second capacitor 404 are placed in series to store the EM energy picked up by inductor 208. Inductor 208 oscillates with the EM field 450, shown in FIG. 4B, induced by the digitizer 100. During a positive phase 452 of the oscillation, first capacitor 402 is charged through a first diode 406. During a negative phase 454 of oscillation second capacitor 404 is charged through a second diode 408. In some exemplary embodiments of the invention, a “power good” circuit, such as described above, is used to make sure oscillator 212 is provided with the correct voltage level required for its operation.

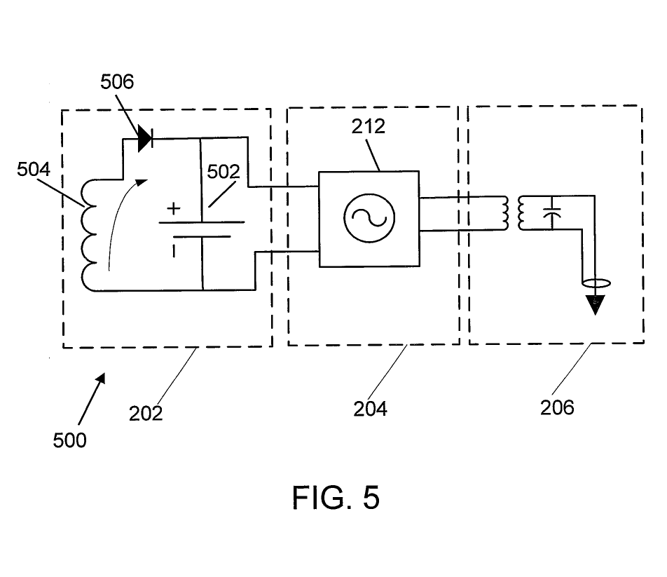

In an exemplary embodiment of the invention, a rechargeable battery operated stylus 500 is optionally used, as shown in FIG. 5. A rechargeable battery 502 is optionally charged by an energy pick-up circuit such as an inductor 504 in combination with a diode 506, a diode bridge or other rectifying means. Additionally or alternatively, battery 502 can be charged in a designated space within the digitizer system or host computing device. In some cases, when battery 502 provides a fixed and stable voltage to oscillator 212, the voltage regulating circuit of other embodiments is not necessary. Optionally other power supply units such as solar cells are used. In some exemplary embodiments of the invention, a synchronization circuit is added to power supply section 202 in order to synchronize the generation of a signal from oscillator 212 with the excitation signal from digitizer 100. Optionally, a “power-good” circuit is 302 added to power supply section 202 in order to disable oscillator 212 in cases where the voltage is below a certain predetermined threshold.

### Exemplary Embodiments with More Than One Power Supply Section

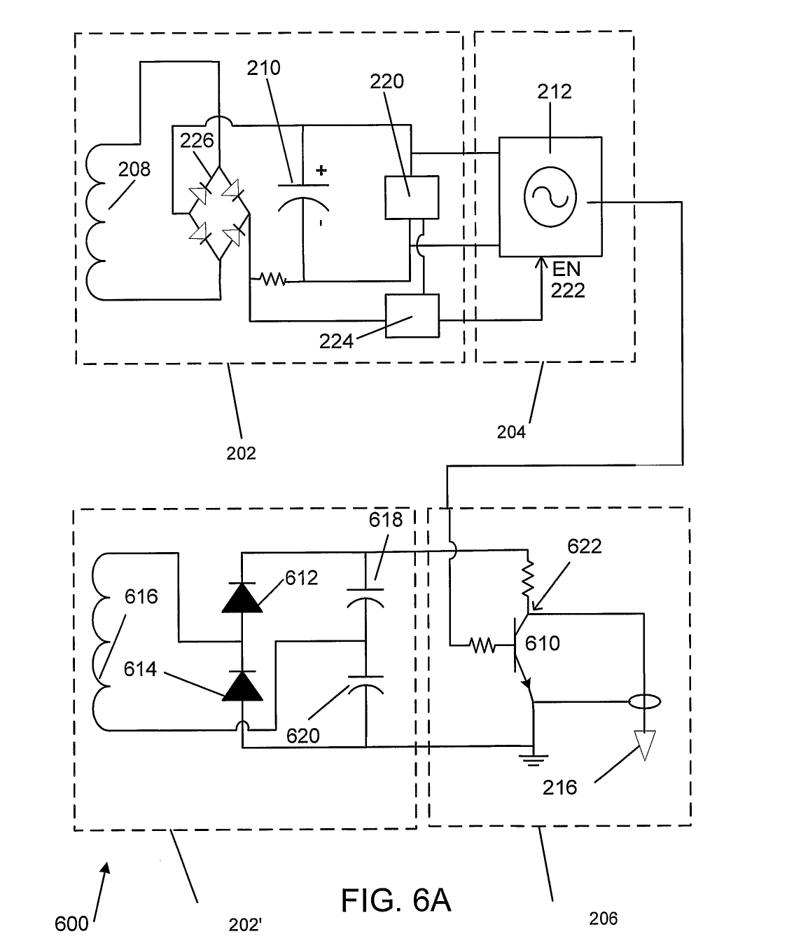

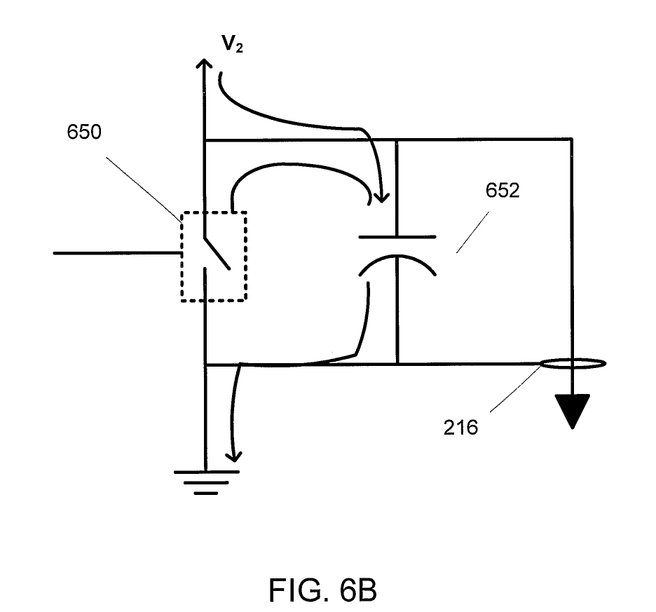

FIG. 6A, shows a schematic 600 of an electrical configuration of a dual power supply electromagnetic stylus is depicted, in accordance with an exemplary embodiment of the invention. In some exemplary embodiments of the invention, the EM stylus is comprised of at least four main sections: an oscillator power supply section 202; an oscillator section 204; a tip power supply section 202′; and, a transmission section 206. In an exemplary embodiment of the invention, oscillator power supply section 202 is designed as an energy pick-up circuit, optionally similar to other energy pick-up circuits described herein, which receives energy from an electromagnetic wave transmitted by digitizer 100 and supplies oscillator section 204. In some exemplary embodiments of the invention, a “power good” circuit, such as described above, is used to make sure oscillator 212 is provided with the correct voltage level required for its operation. The frequency of the oscillator 212 and the frequency of the wave transmitted from digitizer 100 to oscillator power supply section 202 are not related in any way. Oscillator 212 is operationally connected to a transistor 610 which is found in transmission section 206. Transistor 610 functions as an off/on switch for tip 216 in some exemplary embodiments of the invention.

In an exemplary embodiment of the invention, tip power supply section 202′ is used to charge a capacitor, as described below. This is optionally achieved by loading a first capacitor 618 and a second capacitor 620 with energy from an inductor 616. In an exemplary embodiment of the invention, first capacitor 618 and second capacitor 620 are placed in series to store the EM energy picked up by inductor 616. Inductor 616 oscillates with the EM field induced by digitizer 100. During the positive phase of the oscillation, first capacitor 618 is charged through a first diode 612. During the negative phase of oscillation second capacitor 620 is charged through a second diode 614. This configuration of two capacitors 618, 620 in series, connected to inductor 616 through diodes 612, 614, is optionally used to supply relatively high voltage at one of the transistor 610 terminals 622, known as the collector terminal. This configuration is known as a voltage doubler. The present invention is not limited to the voltage doubler described herein, any configuration that will supply sufficiently high output voltage at stylus tip 216 would be suitable. In some exemplary embodiments of the invention, at least 9V is supplied to stylus tip 216. Optionally, up to 15V is supplied to stylus tip 216.

In an exemplary embodiment of the invention, tip power supply section 202′ is connected to collector terminal 622. An oscillator output 624 is connected to a base of transistor 610, controlling the flow of current within the transistor. Collector terminal 622 is also connected to stylus tip 216, in an exemplary embodiment of the invention. In some exemplary embodiments of the invention, transistor 610 is a bipolar junction transistor (“BJT”). Transistor 610 can be said to be analogous to a switch 650 combined with an output capacitor 652, as seen in FIG. 6B. Oscillator output 624 controls the switch 650, in an exemplary embodiment of the invention. When switch 650 is open, capacitor 652 is charged to a voltage necessary for operating tip 216 in accordance with an exemplary embodiment of the invention. When switch 650 is closed, it allows capacitor 652 to discharge.

In an exemplary embodiment of the invention, the inductors 208 and 616 are bound around a single ferrite core (not shown). Other embodiments have two separate ferrite cores, one for each inductor 208 and 616. Furthermore, it is possible to use two types of ferrite cores, either connected or separate. Using two ferrite cores of different characteristics is mostly beneficial in fitting the cores to the stylus dimensions and maximizing energy reception.

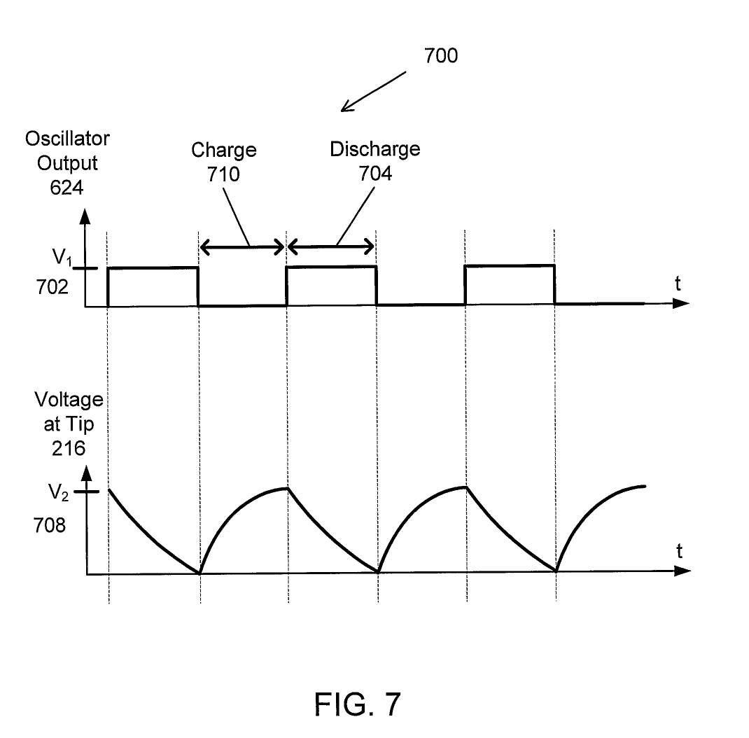

Referring to FIG. 7, a wave form at oscillator output 624 and a resulting waveform at the stylus tip 216 are shown in accordance with an exemplary embodiment of the invention. When oscillator output 624 is high, V₁ 702, current can flow through transistor 610, allowing the transistor's internal capacitance to discharge 704. When the oscillator output is low 706, the internal capacitance within the transistor 610 is charged 710 to the voltage supplied by tip power supply section 202′, V₂ 708. Transistor 610 along with tip power supply section 202′ optionally replaces the transmission section 206 described in FIG. 2A in some exemplary embodiments of the invention. This configuration optionally allows better utilization of the energy transmitted by digitizer 100, while ensuring relatively high signal amplitude (V₂) at stylus tip 216. The invention is not limited to the use of a BJT at transmission section 206 or the use of an output capacitance. Any configuration that will allow a suitable AC signal at stylus tip 216 can optionally be used as a transmission section.

### Exemplary Pressure Sensitive Embodiments

In some exemplary embodiments of the invention, a stylus is provided which is capable of regulating its oscillation frequency in accordance with varying pressure exerted on the stylus. Optionally, the pressure is exerted at a tip of the stylus. Additionally or alternatively, pressure is exerted on the exterior of the stylus. Optionally, at least one button is located on the exterior stylus, to be used by a user to exert pressure on the stylus. Optionally, exerted pressure is used to achieve different functions, such as mouse emulation (“right-click”, etc. . . . ), eraser and/or color change.

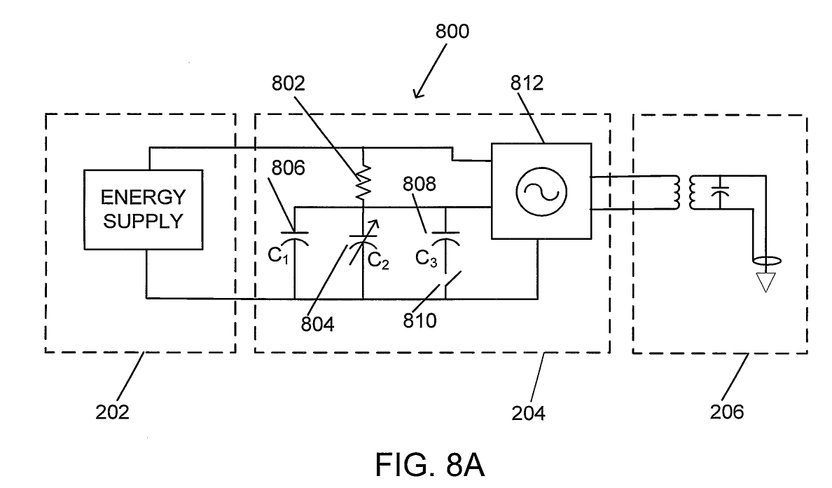

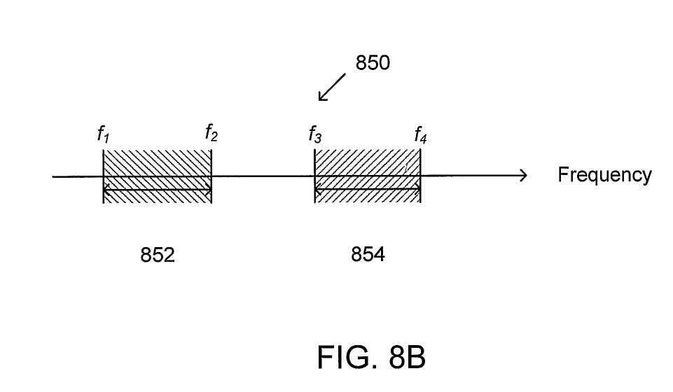

FIG. 8A is a schematic 800 showing an electrical configuration of a pressure sensitive stylus in accordance with an exemplary embodiment of the invention. The power supply and transmission sections are optionally similar to those described in detail herein. In an exemplary embodiment of the invention, a combination of capacitors and a resistor 802 is used to control the oscillation frequency of the stylus. The pressure applied to the stylus tip modulates a variable capacitor 804, optionally connected in parallel to a capacitor 806. In some exemplary embodiments of the invention, an additional capacitor 808 is connected in parallel through a mechanical switch 810. Mechanical switch 810 is optionally manipulated by a user-operated button located on the stylus housing. While the button is generally used to vary the oscillation frequency of an oscillator 812, in an exemplary embodiment of the invention, the functionality of the stylus's side button is to provide a “right click” operation when the stylus is used for mouse emulation. The total capacitance of all three capacitors 804 (C₁), 806 (C₂), 808 (C₃) determines the oscillation frequency of oscillator 812, in accordance with an exemplary embodiment of the invention. When mechanical switch 810 is OFF, excluding capacitor 808 from the circuit and there is no pressure applied to the tip, the total capacitance can be expressed: C_{Total}=C₁+C₂. The present invention is not limited to a variable capacitor; optionally a variable inductance is used.

FIG. 8B shows a diagram 850 of relative frequency ranges achieved using a pressure sensitive stylus, in accordance with an exemplary embodiment of the invention. The total capacitance when mechanical switch 810 is OFF will set the oscillation frequency to a certain value f₁. Since the variable capacitor 804 is optionally tuned within a finite relatively small range of capacitances, the oscillation frequency varies within a corresponding finite range of frequencies [f₁ . . . f₂] 852. When mechanical switch 810 is turned ON, additional capacitor 808 is added to the equation, allowing the expression of the total capacitance to be: Cₜₒₜₐₗ=C₁+C₂+C₃. In an exemplary embodiment of the invention, the additional capacitor 808 produces a shift in the frequency range to [f₃ . . . f₄] 854, in a way that allows complete distinction between the frequency ranges 852 and 854. A detected change in frequency signals to digitizer 100 to perform an action corresponding to the change.

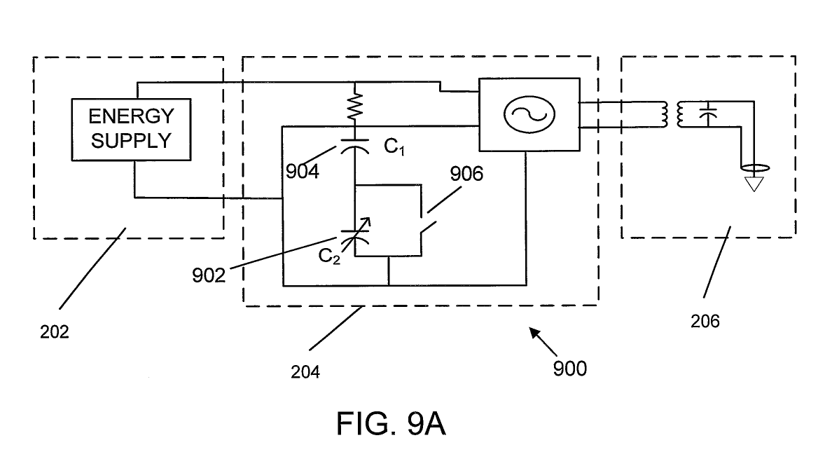

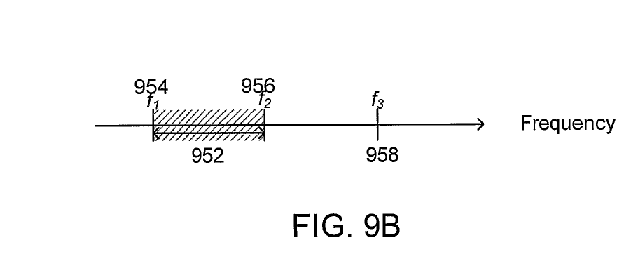

FIG. 9A is schematic 900 of an exemplary embodiment of a pressure sensitive stylus where a variable capacitor 902 is connected to a primary capacitor 904 in series. A button on the stylus housing controls a mechanical switch 906 which excludes variable capacitor 902 from the oscillator circuit. When mechanical switch 906 is OFF, that is open, the total capacitance can be expressed as:

$${C}_{Total} = {( \frac{1}{{C}_{1}} + \frac{1}{{C}_{2}} )}^{- 1}$$

In this exemplary embodiment of the invention, the frequency varies within a relatively small finite range [f₁ . . . f₂] 952, as seen in FIG. 9B. When there is no pressure applied to the stylus tip, the oscillator frequency is either f₁ 954 or f₂ 956. When mechanical switch 906 is ON, that is closed, the total capacitance is that of the primary capacitor 904. In an exemplary embodiment of the invention, this results in an oscillator frequency of f₃ 958.

It should be noted that in some exemplary embodiments of the invention, a plurality of buttons are used to change the stylus frequency either to a single frequency or an additional range of frequencies. Such buttons could be used to provide functionalities such as an eraser or change of color.

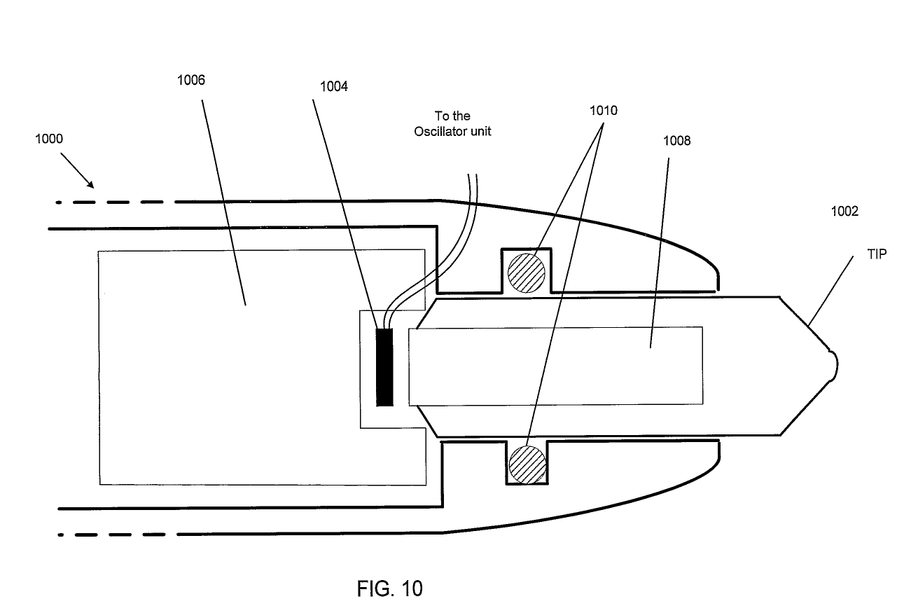

FIG. 10 shows a schematic representation of an exemplary embodiment of a pressure sensitive stylus 1000. In some exemplary embodiments of the invention, a combination of at least one capacitor and at least one resistor is used to control the oscillation of the stylus 1000. In an exemplary embodiment of the invention, pressure applied to a stylus tip 1002 modulates a variable resistor 1004 located proximal to stylus tip 1002. Variable resistor 1004 is located between two ferrites. An inductor is wound around a first ferrite 1006 in some exemplary embodiments of the invention. First ferrite 1006 is optionally provided with a recess, wherein variable resistor 1004 is positioned and optionally wherein a second ferrite 1008 can be positioned. In some exemplary embodiments of the invention, when stylus 1000 is not in use, an O-ring 1010 located externally of second ferrite 1008 maintains a space between the two ferrites, to prevent undue force on variable resistor 1004. Optionally, O-ring 1010 is constructed of an elastic material. In an exemplary embodiment of the invention, O-ring 1010 assists movement of stylus tip 1002. For example, when pressure is applied to stylus tip 1002, stylus tip 1002 and second ferrite 1008 move towards variable resistor 1004. This movement submits O-ring 1010, which is elastically positioned around tip 1002 and second ferrite 1008, to torsional forces. In an exemplary embodiment of the invention, when pressure on stylus tip 1002 is released, O-ring 1010 returns to its original position, releasing its torsional energy and providing movement to stylus tip 1002 and second ferrite 1008 away from variable resistor 1004 and back to their original position. It should be noted other conductive elements could be optionally used in place of ferrites. In some exemplary embodiments of the invention, variable resistor 1004 is connected to oscillator section 204. Optionally, the connection is via a flex cable. The invention is not limited to the specified location of the variable resistor. Optionally, the variable resistor is placed in different places relation to the stylus.

As long as no force is applied on the variable resistor 1004, the resistance of resistor 1004 is referred to as “infinity”. In an exemplary embodiment of the invention, resistor's 1004 resistance decreases as a function of the mechanical pressure applied on it.

In some exemplary embodiments of the invention, variable resistor 1004 is optionally used alternatively to some or all of the capacitors described in the embodiments shown in FIGS. 8A and 9A.

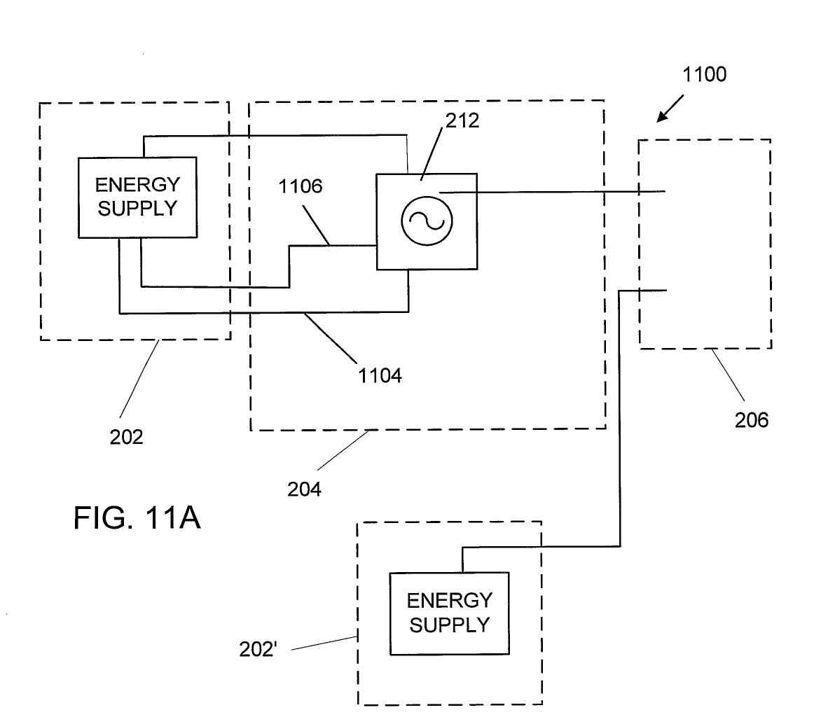

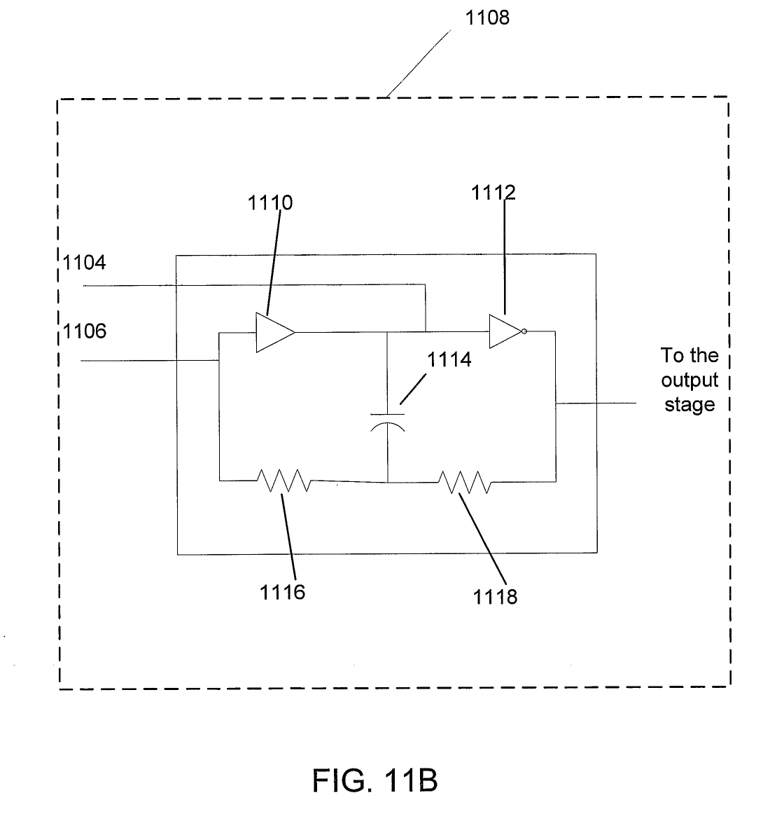

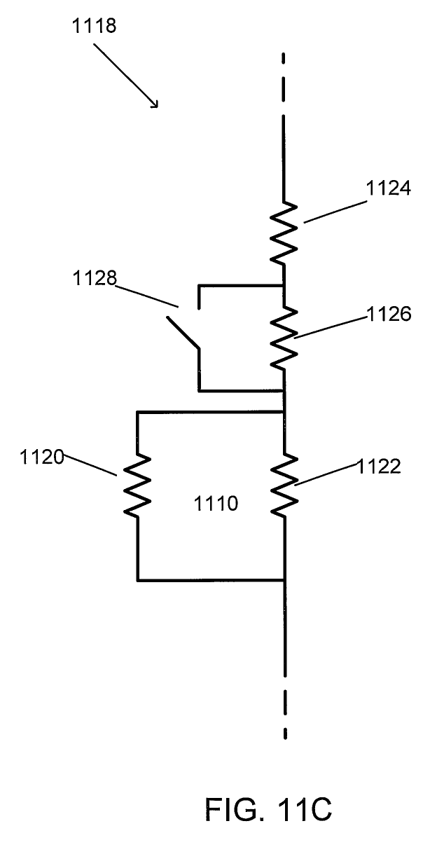

FIG. 11A is a schematic 1100 showing an electrical configuration of a dual power supply, pressure sensitive stylus in accordance with an exemplary embodiment of the invention. In some exemplary embodiments of the invention, an oscillator section 204 receives two input signals to an oscillator 212, a disable signal 1104 from a “power good” circuit, for example “power good” circuit 302 pictured in FIG. 3, and an enable signal 1106 from a synchronization circuit, for example synchronization circuit 224 pictured in FIG. 2A. Optionally, more than one oscillator is used

FIG. 11B is an exemplary circuit diagram of oscillator 212, in accordance with an exemplary embodiment of the invention. It optionally receives two inputs: disable signal 1104 and enable signal 1106. In some exemplary embodiments of the invention, oscillator 212 is provided with an operative connection (not shown) to a power supply unit, such as power supply section 202 of FIG. 2A, to power the circuit. Oscillator is optionally comprised of at least a buffer 1110, a “not” buffer 1112, a capacitor 1114 and two resistors 1116, 1118. In an exemplary embodiment of the invention, second resistor 1118 is actually a pattern of resistors, shown in FIG. 11C, and contains a variable resistor 1120.

FIG. 11C is a schematic showing an electrical configuration of resistor 1118, which is actually a pattern of resistors, in accordance with an exemplary embodiment of the invention. In some exemplary embodiments of the invention, variable resistor 1120 is connected in parallel to a resistor 1122. The two resistors 1120 (R₁), 1122 (R₂) are connected in series to a third resistor 1124 (R₃).

An additional resistor 1126 (R₄) is optionally connected serially using a mechanical switch 1128. The switch is manipulated by a control interface, such as a button, located on the stylus housing. In an exemplary embodiment of the invention, the functionality of the stylus's button is to provide a “right click” operation when the stylus is used for mouse emulation. The total resistance, of all four resistors 1120, 1122, 1124, 1126 determines the oscillation frequency of oscillator 212. When mechanical switch 1128 is OFF, excluding additional resistor 1126 from the circuit, and there is no pressure applied to the tip, the total resistance can be expressed:

$${R}_{tot} = {( \frac{1}{{R}_{1}} + \frac{1}{{R}_{2}} )}^{- 1} + {R}_{3} .$$

In an exemplary embodiment of the invention, the total resistance will set the oscillation frequency to a certain value f₁. Since variable resistor 1120 is optionally tuned within a finite range of resistances, the oscillation frequency varies within a corresponding finite range of frequencies [f₁ . . . f₂] 852.

When the mechanical switch 1128 is turned ON, additional resistor 1126 is added to the equation, allowing the expression of the total resistance to be:

$${R}_{tot} = {( \frac{1}{{R}_{1}} + \frac{1}{{R}_{2}} )}^{- 1} + {R}_{3} + {R}_{4} .$$

In an exemplary embodiment of the invention, additional resistor 1126 produces a shift in the frequency range to [f₃ . . . f₄] 854. The difference in frequency ranges 852 to 854 is significant to enable distinction between the two by digitizer 100. As above, different detected frequencies cause digitizer to optionally execute commands tied to those frequencies which are detected. In some exemplary embodiments of the invention, a functional alternative to the pattern of resistors described herein is used.

In an exemplary embodiment of the invention, temperature compensation unit within the oscillator section 204 is used. This temperature compensation unit is responsible for compensation when a change in the temperature occurs in order to avoid changes in the frequencies of the system due to a change in the temperature, in accordance with an exemplary embodiment of the invention. The temperature compensation unit optionally consists of a variable resistor that changes its resistance as a function of the temperature.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

1. A position detection system, comprising:
at least one pointer, comprising:
a wave generating oscillator section capable of generating oscillating electrical signals;
a power supply section powering generation of said electrical oscillating signals by said oscillator section; and
an energy pick-up circuit which supplies energy to the power supply section from an excitation signal received by said circuit; and,
a detector, comprising a sensor operative to detect the position of said at least one pointer from a wave generated by the wave generating section.

2. A position detection system according to claim 1, wherein the excitation signal is transmitted from said detector.

3. A position detection system according to claim 1, wherein said power supply produces a DC voltage to power the oscillator section.

4. A position detection system according to claim 1, wherein said energy pick-up circuit comprises a coil which is excited by the excitation signal.

5. A position detection system according to claim 1, wherein said power supply section further comprises a rechargeable battery.

6. A position detection system according to claim 5, wherein said rechargeable battery recharges from energy derived by said energy pick-up circuit.

7. A position detection system according to claim 1, wherein said power supply section further comprises a capacitor that is charged from the energy pick-up circuit.

8. (canceled)

9. A position detection system according to claim 2, wherein said pointer further comprises a transmission section that is powered by a transmission power supply section.

10. A position detection system according to claim 9, wherein said transmission power supply section is comprised of a transmission power supply section energy pick-up circuit which is excited by the excitation signal circuit and which supplies energy to the power supply section from the excitation signal.

11. A position detection system according to claim 10, wherein said transmission power supply section energy pick-up circuit comprises a coil which is excited by the excitation signal.

12. A position detection system according to claim 9, wherein said transmission power supply section energy pick-up circuit further comprises a rechargeable battery.

13. A position detection system according to claim 1, wherein said oscillator section further comprises at least a variable element responsive to pressure exerted on said pointer by a user.

14. A position detecting system according to claim 13, wherein when said pressure is exerted, a first frequency generated by said oscillator section changes to a second frequency.

15. A position detecting system according to claim 14, wherein said first frequency corresponds to at least a first executable command and wherein said second frequency corresponds to a second executable command on said detector.

16. A position detecting system according to claim 13, wherein said variable element is a capacitor.

17. A position detecting system according to claim 13, wherein said variable element is a resistor.

18. A position detecting system according to claim 13, wherein said variable element is an inductor.

19. (canceled)

20. A position detection system according to claim 1, wherein said detector is a display.

21. A position detection system according to claim 2, wherein said oscillator section generates a wave at a frequency independent of said excitation signal.

22. A position detection system according to claim 2, wherein said pointer further comprises at least one synchronization circuit which synchronizes said oscillator section wave generation with said excitation signal.

23. A position detecting system according to claim 1, wherein said detector is at least one of: a personal computer, a personal data assistant, a tablet or a mobile phone.

24. A pointer, comprising:
a wave generating oscillator section capable of generating oscillating electrical signals;
a power supply section powering said generation of said electrical oscillating signals by said oscillator section; and
an energy pick-up circuit which supplies energy to the power supply section from an excitation signal received by said circuit; and,
a transmission section that transmits a signal generated by the oscillator section

25. A pointer according to claim 24, wherein said power supply produces a DC voltage to power the oscillator section.

26. A pointer according to claim 24, wherein said power supply section further comprises at least one synchronization circuit which synchronizes said oscillator section signal generation with said excitation signal.

27. A pointer according to claim 24, wherein said energy pick-up circuit comprises a coil which is excited by the excitation signal.

28. A pointer according to claim 24, wherein said power supply section further comprises a rechargeable battery, wherein said rechargeable battery recharges from energy derived by said energy pick-up circuit.

29. (canceled)

30. A pointer according to any claim 24, wherein said power supply section further comprises a capacitor.

31. A pointer according to claim 30, wherein said capacitor is charged from said energy pick-up circuit.

32. (canceled)

33. A pointer according to claim 24, further comprising at least a transmission power supply section powering the transmission section.

34. A pointer according to claim 33, wherein said transmission power supply section is comprised of a transmission power supply section energy pick-up circuit which is excited by the excitation signal and which supplies energy to the transmission power supply section from the excitation signal.

35. A pointer according to claim 34, wherein said transmission power supply section energy pick-up circuit comprises a coil which is excited by the excitation signal.

36. A pointer according to claim 34, wherein said transmission power supply section energy pick-up circuit further comprises a rechargeable battery.

37. A pointer according to claim 24, wherein said oscillator section generates a signal at a frequency independent of said excitation signal.

38. A pointer according to claim 24, wherein said oscillator section further comprises at least a variable element responsive to pressure exerted on said pointer by a user.

39. A pointer according to claim 38, further comprising a button located on an exterior of said pointer wherein said button controls said at least a variable element responsive to pressure exerted on it from said button.

40. (canceled)

41. A pointer according to claim 38, wherein when said pressure is exerted, a first frequency generated by said oscillator section changes to a second frequency.

42. A pointer according to claim 41, wherein said second frequency is one of a relatively narrow range of frequencies.

43. (canceled)

44. A pointer according to claim 39, wherein said variable element is a capacitor.

45. A pointer according to claim 39, wherein said variable element is a pressure sensitive resistor.

46. A pointer according to claim 39, wherein said variable element is an inductor.

47. A method for providing energy to a pointer, comprising:
transmitting an excitation signal from a detector;
generating a DC voltage from said excitation signal; and,
powering generation of electrical oscillating signals by an oscillator from said DC voltage.

48. A stylus for use in a digitizer system, comprising:
a stylus tip;
at least one moving element located in the stylus, wherein said at least one moving element moves in response to pressure applied on the stylus tip;
at least one elastic element fitted around an outer circumference of said at least one moving element and coupled to a housing of the stylus such that during said motion of said moving element, torsion is applied to said elastic element and wherein said elastic element torsion opposes motion of said moving element and returns said moving element to a condition that existed prior to said motion.

49. A stylus according to claim 48, wherein said elastic element is an o-ring.

50. A stylus according to claim 48, wherein said moving element is a conductive element.

51. A stylus according to claim 48 further comprising a variable element, wherein said variable element modulates in response to motion of said at least one moving element towards said variable element.

52. A stylus according to claim 50, wherein said conductive element is a ferrite.

53. A stylus according to claim 51, wherein said variable element is a resistor.

54. A stylus according to claim 51, wherein said variable element is a capacitor.

55. A stylus according to claim 51, further comprising an oscillator section in operative communication with said variable element.

56. A stylus according to claim 51, wherein pressure exerted on said stylus tip causes motion of said at least one moving element towards said variable element.

57. A stylus for use in a digitizer system, comprising:
a stylus tip;
an oscillator producing an electrical signal; and
a variable element forming a part of the oscillator,
wherein the stylus is operative when pressure is exerted on a tip thereof to transmit pressure via a force transmitting element to said variable element such that the value of said variable element modulates in response to pressure exerted on said stylus tip.

58. A stylus according to claim 57, further comprising at least one o-ring positioned around said force transmitting element and coupled to a housing of said stylus such that during motion of said force transmitting element, torsion is applied to said o-ring and wherein said o-ring torsion opposes motion of said force transmitting element towards said variable element.

59. A stylus according to claim 58, wherein said o-ring torsion provides a force to return said force transmitting element to a condition that existed prior to said motion towards said variable element.

60. A stylus according to claim 57, wherein said variable element is a variable resistor.

61. A stylus according to claim 57, wherein said variable element is a variable capacitor.

62. A pointer, comprising:
a wave generating oscillator section capable of generating oscillating electrical signals responsive to an excitation signal;
a transmission section that transmits a signal generated by the oscillator section:
a power supply section powering said transmission section; and
an energy pick-up circuit which supplies energy to the power supply section from an excitation signal received by said circuit.

63. A pointer according to claim 62, wherein said power supply produces a DC voltage to power the transmission section.

64. A pointer according to claim 62, wherein said energy pick-up circuit comprises a coil which is excited by the excitation signal.

65. A pointer according to claim 62, wherein said power supply section further comprises a rechargeable battery, wherein said rechargeable battery recharges from energy derived by said energy pick-up circuit.

66. A pointer according to claim 62, wherein said power supply section further comprises a capacitor that is charged from said energy pick-up circuit.
